(19) United States
(12) Patent Application Publication
(10) Pub. No.: US 2026/0340267 A1
(43) Pub. Date: Oct. 29, 2026

(54) INFORMATION PROVIDING DEVICE, INFORMATION PROVIDING METHOD, AND RECORDING MEDIUM

(71) Applicant: NEC Corporation, Tokyo (JP)

(72) Inventors: Toshihiko IMAI, Tokyo (JP); Marina ADACHI, Tokyo (JP); Shingo MORIGAKI, Tokyo (JP); Wataru TAKAYANAGI, Tokyo (JP); Kentaro MAEDA, Tokyo (JP)

(73) Assignee: NEC Corporation, Tokyo (JP)

(21) Appl. No.: 19/646,846

(22) Filed: Apr. 14, 2026

(30) Foreign Application Priority Data
Apr. 25, 2025 (JP) 2025-073167

(51) Int. Cl. G06F 40/169; G06F 16/93

(52) U.S. Cl. CPC G06F 40/169; G06F 16/93

(57) ABSTRACT

There is provided an information providing device including an input request unit for requesting an input of a pre-change document and a post-change document, an identification unit for identifying a changed portion of a document by comparing the pre-change document with the post-change document, an estimation unit for estimating a change purpose of the changed portion identified by the identification unit by inputting the changed portion and instruction information for requesting estimation of the change purpose of the changed portion to a generative model that outputs the change purpose of the changed portion using, as an input, the changed portion and the instruction information for requesting the estimation of the change purpose of the changed portion, and an output unit for outputting output information including the changed portion and the change purpose.

This application is based upon and claims the benefit of priority from Japanese Patent Application No. 2025-073167, filed on Apr. 25, 2025, the disclosure of which is incorporated herein in its entirety by reference.

### TECHNICAL FIELD

The present disclosure relates to an information providing device, an information providing method, and a recording medium.

### BACKGROUND ART

There is known a technique for supporting document understanding of a reader in a case where a change is made to a document. For example, JP 2023-058686 A discloses that, after a button displayed on a prompt screen is pressed, information obtained by extracting a line in which a change is made to a document is displayed on the prompt screen. In the extracted line, added text is underlined, and deleted text is struck through.

### SUMMARY

An object of the present disclosure is to provide an information providing device, an information providing method, and a recording medium for supporting efficient document understanding in a case where a change is made to a document.

An information providing device according to an aspect of the present disclosure includes an input request means for requesting an input of a pre-change document and a post-change document, an identification means for identifying a changed portion of a document by comparing the pre-change document with the post-change document, an estimation means for estimating a change purpose of the changed portion identified by the identification means by inputting the changed portion and instruction information for requesting estimation of the change purpose of the changed portion to a generative model that outputs the change purpose of the changed portion using, as an input, the changed portion and the instruction information for requesting the estimation of the change purpose of the changed portion, and an output means for outputting output information including the changed portion and the change purpose.

An information providing method according to an aspect of the present disclosure causes a computer to perform a process of requesting an input of a pre-change document and a post-change document, identifying a changed portion of a document by comparing the pre-change document with the post-change document, estimating a change purpose of the changed portion identified by the identification means by inputting the changed portion and instruction information for requesting estimation of the change purpose of the changed portion to a generative model that outputs the change purpose of the changed portion using, as an input, the changed portion and the instruction information for requesting the estimation of the change purpose of the changed portion, and outputting output information including the changed portion and the change purpose.

A computer program according to an aspect of the present disclosure causes a computer to perform a process of requesting an input of a pre-change document and a post-change document, identifying a changed portion of a document by comparing the pre-change document with the post-change document, estimating a change purpose of the changed portion identified by the identification means by inputting the changed portion and instruction information for requesting estimation of the change purpose of the changed portion to a generative model that outputs the change purpose of the changed portion using, as an input, the changed portion and the instruction information for requesting the estimation of the change purpose of the changed portion, and outputting output information including the changed portion and the change purpose.

### BRIEF DESCRIPTION OF THE DRAWINGS

Exemplary features and advantages of the present disclosure will become apparent from the following detailed description if taken with the accompanying drawings in which:

FIG. 1 is a conceptual diagram for explaining an overview of an information providing system according to the present disclosure;

FIG. 2 is a block diagram illustrating an exemplary configuration of an information providing device according to the present disclosure;

FIG. 3 is a diagram illustrating an exemplary document input request screen according to the present disclosure;

FIG. 4 is a diagram illustrating exemplary output information according to the present disclosure;

FIG. 5 is a flowchart illustrating an exemplary operation of the information providing device according to the present disclosure;

FIG. 6 is a block diagram illustrating an exemplary configuration of the information providing device according to the present disclosure;

FIG. 7 is a flowchart illustrating an exemplary operation of the information providing device according to the present disclosure; and

FIG. 8 is a diagram illustrating an exemplary hardware configuration in which the information providing device according to the present disclosure is implemented by a computer device including a processor.

### DETAILED DESCRIPTION OF THE DRAWINGS

### Example Embodiment

Hereinafter, example embodiments in the present disclosure will be described in detail while referring to the drawings. While the example embodiments to be described below have technically preferable limitations for carrying out the present disclosure, the scope of the invention is not limited to the following. In all the drawings to be used to explain the following example embodiments, the same reference signs are given to similar parts unless otherwise specified. In the following example embodiments, repeated descriptions of similar configurations and operations may be omitted in some cases. A user interface (UI) illustrated in the drawings is an example, and may be replaced with another UI.

### First Example Embodiment

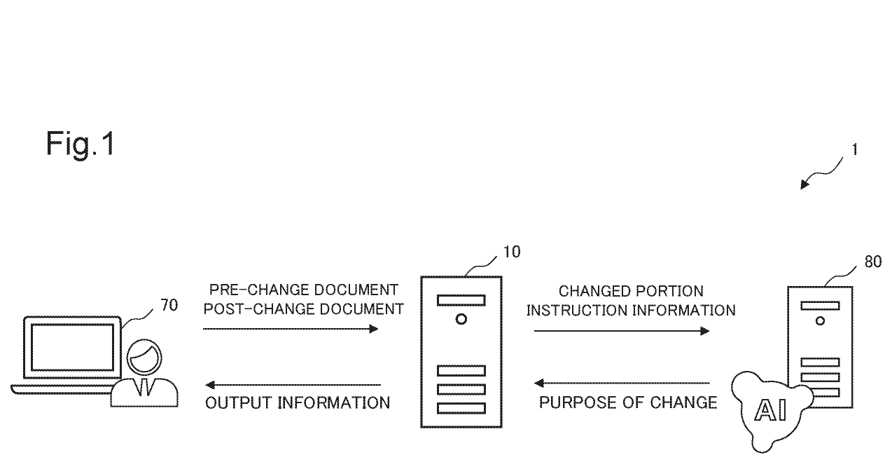

First, an overview of an information providing system according to a first example embodiment will be described with reference to the drawings. FIG. 1 is a conceptual diagram for explaining an overview of an information providing system according to the present disclosure. An overview of a processing flow of an information providing system 1 will be described with reference to FIG. 1.

First, an information providing device 10 requests a user terminal 70 to input a pre-change document and a post-change document, thereby obtaining the pre-change document and the post-change document. The pre-change document is a document before a change is made. The post-change document is a document after the change is made. The information providing device 10 compares the pre-change document with the post-change document to identify a changed portion of the document. The information providing device 10 further inputs the identified changed portion and instruction information to a generative model stored in a server 80. The instruction information is a prompt for requesting estimation of a purpose of the change in the changed portion. The information providing device 10 obtains the purpose of the change output from the generative model. The information providing device 10 further outputs output information including the changed portion and the purpose of the change to the user terminal 70.

The purpose of the change is a purpose of the change made to the pre-change document in the post-change document. The change indicates addition, deletion, or replacement of text in the document. Examples of the purpose of the change include information update, error correction, a change for clarification, a format change, reflection of an organizational change, a response to feedback from another person, and security enhancement. The purpose of the change is not limited to the examples described above, and may be set as appropriate.

The user terminal 70 is an information processing device operated by a reader of the document. For example, the user terminal 70 is achieved by a stationary terminal device, a portable terminal device, or a general-purpose information processing device such as a server. While the number of the user terminals 70 is one in the example of FIG. 1, this is an example. There may be a plurality of the user terminals 70.

The server 80 is a server that stores and executes the generative model. The server 80 is not limited to a server as long as it is an information processing device capable of implementing this function. Examples of the generative model include a large language model (LLM). While the server 80 and the information providing device 10 are illustrated as separate configurations in the present example embodiment, they are not limited thereto. The information providing device 10 may have the function of the server 80.

### Configuration

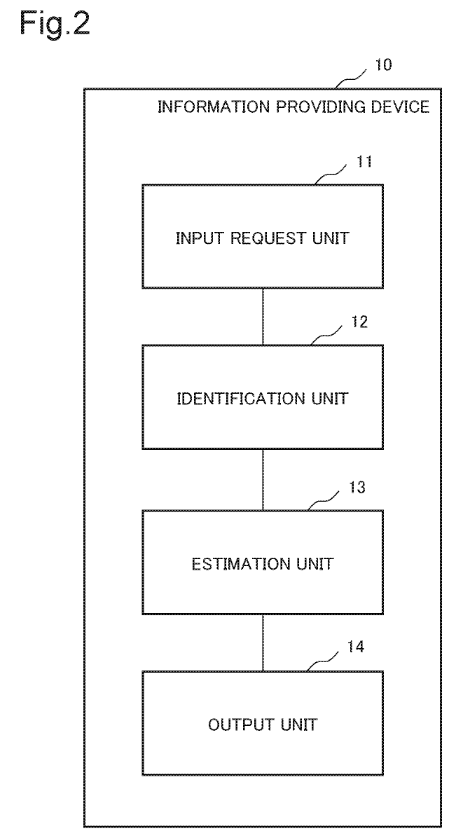

Next, a configuration of the information providing device will be described with reference to FIG. 2. FIG. 2 is a block diagram illustrating an exemplary configuration of the information providing device according to the present disclosure.

The information providing device 10 is achieved by a stationary terminal device, a portable terminal device, or a general-purpose information processing device such as a server device. The information providing device 10 is communicably connected to each of the user terminal 70 and the server 80. As illustrated in FIG. 2, the information providing device 10 includes an input request unit 11, an identification unit 12, an estimation unit 13, and an output unit 14.

The input request unit 11 requests an input of the pre-change document and post-change document. For example, the input request unit 11 causes a display unit of the user terminal 70 to display an input interface, such as a web browser, thereby requesting an input of the pre-change document and post-change document.

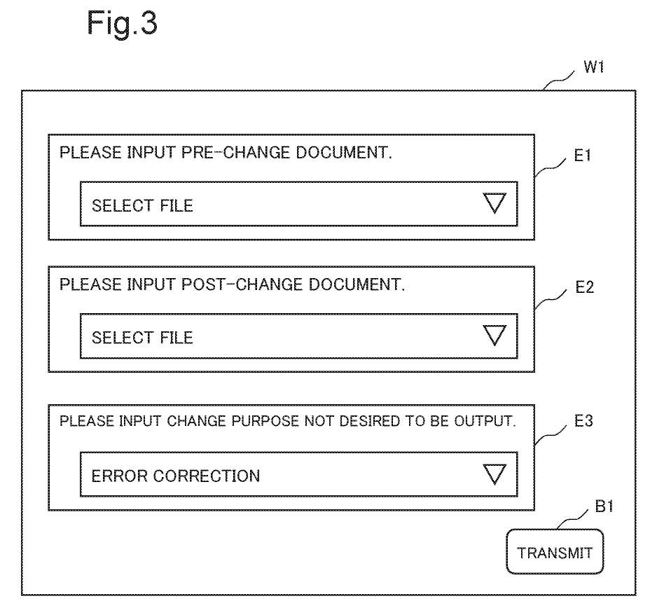

FIG. 3 is a diagram illustrating an exemplary document input request screen according to the present disclosure. For example, the input request unit 11 causes the display unit of the user terminal 70 to display an input interface as illustrated in a document input request screen W1. The document input request screen W1 includes a UI component E1 for requesting an input of the pre-change document, and a UI component E2 for requesting an input of the post-change document. Upon input of the pre-change document and post-change document, an operator of the user terminal 70 presses a button B1. When it is detected that the button B1 is pressed, the user terminal 70 transmits the input information to the information providing device 10. The input request unit 11 obtains the information transmitted from the user terminal 70.

The input request unit 11 may further request an input of a change purpose not desired to be output. For example, as illustrated in FIG. 3, the document input request screen W1 includes a UI component E3 for requesting an input of a change purpose not desired to be output. The UI component E3 is, for example, a pull-down UI component having a list of change purposes as items. The operator of the user terminal 70 inputs one or a plurality of change purposes via the UI component E3. A change purpose not desired to be output may not be input.

The post-change document may include change history information, which is a history of changed portions in the document. In that case, the input request unit 11 may automatically extract information corresponding to the pre-change document from the change history information included in the post-change document. In that case, the input request unit 11 may not receive an input of the pre-change document from the user terminal 70. If a plurality of changes has been made in the document, there may be a plurality of candidates of the pre-change document specified by the change history information. In such a case, the input request unit 11 may request the operator of the user terminal 70 to input specific information for identifying the pre-change document. Examples of the specific information include a change date and time and a version of the document included in the change history information. The input request unit 11 automatically extracts, using the specific information, the pre-change document desired by a user from the plurality of candidates of the pre-change document.

The identification unit 12 compares the pre-change document with the post-change document to identify a changed portion of the document. For example, the identification unit 12 identifies the changed portion as follows. First, the identification unit 12 divides the pre-change document and the post-change document into tokens by natural language processing. The identification unit 12 detects a difference between the text of the pre-change document and the text of the post-change document. If there is a token in which a difference is detected, the identification unit 12 identifies the pre-change token and the post-change token as the changed portion. The identification unit 12 may identify, as the changed portion, a phrase, sentence, or paragraph including the token in which the difference is detected. The identification unit 12 may further identify a position in the document of the token in which the difference is detected. Examples of the position in the document include a page number, line number, paragraph number, and chapter number of the document. There may be one or a plurality of the changed portions identified by the identification unit 12. The identification unit 12 may identify the changed portion using not only the method described above but also various known methods.

The estimation unit 13 inputs, to a generative model, the changed portion and instruction information for requesting estimation of a purpose of the change in the changed portion, thereby estimating the purpose of the change in the changed portion. The generative model is a model that outputs a change purpose using a changed portion and instruction information as inputs. The instruction information is a prompt to be input to the generative model. The instruction information includes an instruction for requesting estimation of a purpose of the change in the changed portion. For example, the instruction information is “Refer to the contents before and after the change and estimate a purpose of the change” or the like. The generative model may be a model tuned to estimate a purpose of the change in the changed portion. If a plurality of changed portions is identified by the identification unit 12, the estimation unit 13 estimates purposes of the changes in the plurality of changed portions.

The output unit 14 outputs output information including the changed portion and the purpose of the change. The output unit 14 generates the output information. The output unit 14 outputs the generated output information. For example, the output unit 14 outputs the output information to the user terminal 70. The output destination of the output information is not limited to the user terminal 70, and for example, it may be output to a display unit (not illustrated) of the information providing device 10.

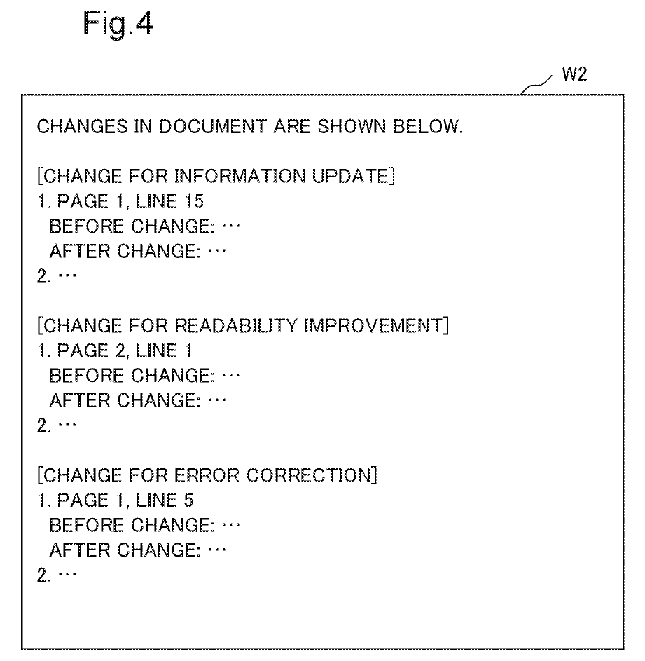

FIG. 4 is a diagram illustrating an example of the output information according to the present disclosure. For example, the output unit 14 generates output information as illustrated in output information W2. The output information W2 includes a pre-change token, a post-change token, and a purpose of the change for the changed portion identified by the identification unit 12. The output information W2 may include not only the changed token but also a sentence including the changed token. The output information W2 may further include sentences before and after the sentence including the changed token. With the output of not only the changed token but also preceding and following sentences, it becomes possible to support efficient document understanding of the reader. If a plurality of changed portions is identified by the identification unit 12, as illustrated in FIG. 4, the output unit 14 may generate output information in which the changed portions are grouped for each change purpose.

The output unit 14 may not include a changed portion based on a specific change purpose in the output information. For example, if a plurality of changed portions is identified by the identification unit 12 and change purposes of the plurality of changed portions are estimated by the estimation unit 13, the output unit 14 does not include, in the output information, a changed portion based on a predetermined change purpose among the plurality of change purposes. For example, the predetermined change purpose may be a change that does not affect the content, such as error correction, a format change, a layout change, or the like. If an input of a change purpose not desired to be output has been received by the input request unit 11, the output unit 14 generates output information not including the changed portion associated with the change purpose for which the input indicating that an output is not desired has been received, among the plurality of change purposes estimated by the estimation unit 13. For example, it is assumed that the input request unit 11 has received an input indicating that a change for the purpose of “error correction” is not desired to be output. In that case, the output unit 14 does not include, in the output information, information regarding a changed portion whose change purpose estimated by the estimation unit 13 is associated with “error correction”.

### Operation

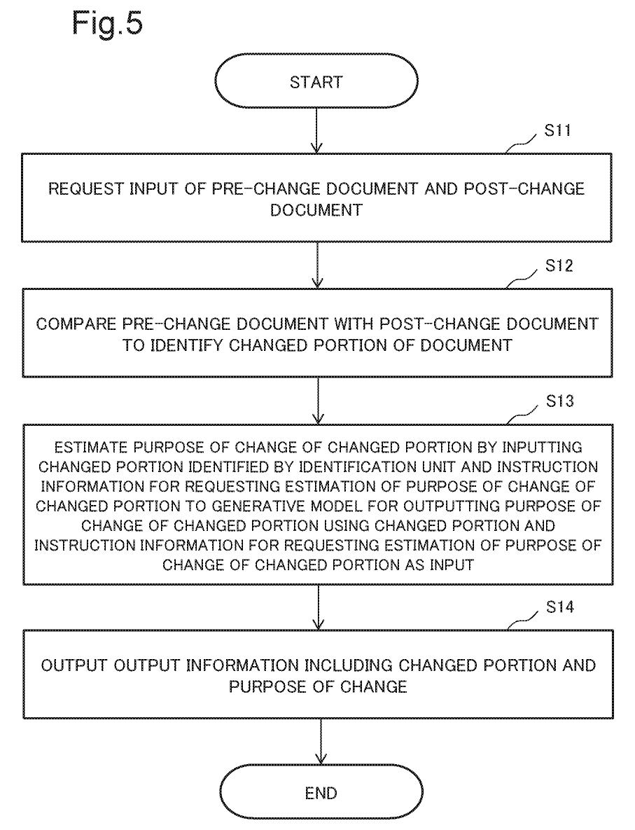

Next, an operation of the information providing device 10 according to the present example embodiment will be described with reference to FIG. 5. FIG. 5 is a flowchart illustrating an exemplary operation of the information providing device according to the present disclosure.

First, the input request unit 11 requests an input of the pre-change document and post-change document (step S11). For example, the input request unit 11 causes the display unit of the user terminal 70 to display the input interface, thereby requesting an input of the pre-change document and post-change document.

Next, the identification unit 12 compares the pre-change document with the post-change document to identify a changed portion of the document (step S12).

Next, the estimation unit 13 inputs, to the generative model, the changed portion and the instruction information for requesting estimation of a purpose of the change in the changed portion, thereby estimating the purpose of the change in the changed portion (step S13). The instruction information is a prompt to be input to the generative model. Examples of the generative model include a large language model.

Next, the output unit 14 outputs output information including the changed portion and the purpose of the change (step S14). Upon completion of the processing of step S14, the information providing device 10 terminates the series of processing described above.

As described above, the information providing device according to the present example embodiment includes the input request unit, the identification unit, the estimation unit, and the output unit. The input request unit requests an input of the pre-change document and post-change document. The identification unit compares the pre-change document with the post-change document to identify a changed portion of the document. The estimation unit inputs the changed portion identified by the identification unit and the instruction information for requesting estimation of a purpose of the change in the changed portion to the generative model that outputs a purpose of the change in the changed portion using the changed portion and the instruction information for requesting estimation of a purpose of the change in the changed portion as inputs, thereby estimating a purpose of the change in the changed portion. The output unit outputs output information including the changed portion and the purpose of the change.

The information providing device according to the present example embodiment estimates a purpose of the change in the changed portion by inputting, to the generative model, the changed portion and the instruction information for requesting estimation of the purpose of the change in the changed portion, and outputs the output information including the purpose of the change. That is, the information providing device according to the present example embodiment provides the output information including the purpose of the change of the document. The reader of the document who checks the output information is enabled to determine importance of the change depending on the purpose of the change of the document. This allows the reader to read the document by prioritizing the changes depending on their importance, whereby the reader may efficiently understand the document within a limited time. That is, according to the information providing device according to the present example embodiment, it becomes possible to support efficient document understanding in a case where a change is made to the document. The effect described above is particularly remarkable in a case where the document is large in volume or in a case where many changed portions are included in the document.

Some changes in the document are important to the reader, and some changes are not. The reader is enabled to efficiently understand the document within a limited time by reading the document while prioritizing the changes depending on their importance. The technique disclosed in JP 2023-058686 A merely provides information regarding changed portions of a document, and does not provide information to serve as an index for determining importance. That is, according to the technique disclosed in JP 2023-058686 A, efficient document understanding in a case where a change is made to the document may not be supported.

According to the present disclosure, it becomes possible to provide an information providing device, an information providing method, and a computer program capable of supporting efficient document understanding in a case where a change is made to a document.

In the information providing device according to an aspect of the present example embodiment, the output unit does not include a changed portion whose change purpose is error correction in the output information. As a result, it becomes possible not to include, in the output information, a changed portion for the purpose of “error correction”, which is assumed to be information of low importance for the reader. That is, according to the information providing device according to an aspect of the present example embodiment, it becomes possible to support efficient document understanding in a case where a change is made to the document.

In the information providing device according to an aspect of the present example embodiment, the input request unit requests an input of a change purpose not desired to be output. The estimation unit estimates a plurality of change purposes in the changed portions. The output unit generates output information not including the changed portions associated with the change purpose for which the input indicating that an output is not desired has been received among the plurality of change purposes. As a result, it becomes possible not to include, in the output information, information regarding the changed portions of low importance for the reader. That is, according to the information providing device according to an aspect of the present example embodiment, it becomes possible to support efficient document understanding in a case where a change is made to the document.

### Second Example Embodiment

Next, an information providing device according to the present example embodiment will be described with reference to the drawings. In the following descriptions, the same reference signs are given to parts similar to those of the first example embodiment, and descriptions thereof will be omitted as appropriate. The information providing device according to the present example embodiment is different from the information providing device according to the first example embodiment in that message information of a corrector of a document is obtained and a change history of the document is estimated using the message information. The information providing device according to the present example embodiment is different from the information providing device according to the first example embodiment also in that a proposed revision for a post-change document is generated. The information providing device according to the present example embodiment is further different from the information providing device according to the first example embodiment in that attribute information of a reader is obtained and information to be included in output information is changed depending on the attribute information.

### Configuration

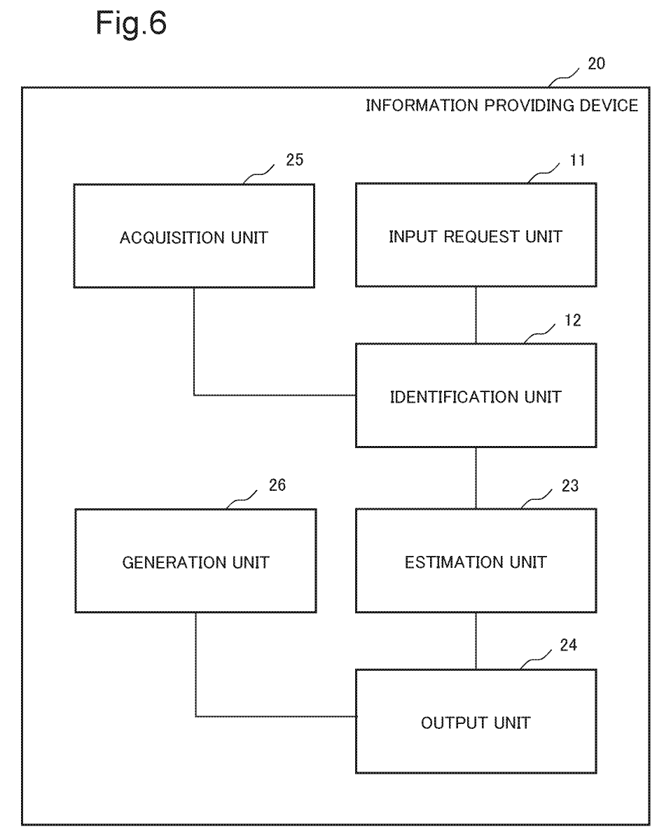

FIG. 6 is a block diagram illustrating an exemplary configuration of the information providing device according to the present disclosure. As illustrated in FIG. 6, an information providing device 20 includes an input request unit 11, an identification unit 12, an estimation unit 23, an output unit 24, an acquisition unit 25, and a generation unit 26.

The acquisition unit 25 obtains the message information of the document corrector. The message information is content of a message transmitted and received by the document corrector using a message application. The message information includes information regarding a comment that has caused the document to be changed. Examples of the message application include a mail application, a chat application, and a call application. The acquisition unit 25 refers to a database that stores a message history of those message applications to obtain the message information. The message information obtained by the acquisition unit 25 may have time period designation. For example, the message information obtained by the acquisition unit 25 may be specified in advance as being from the most recent month. The acquisition unit 25 may obtain the message information with a predetermined user. For example, the acquisition unit 25 may obtain the message information with a person in charge of checking of the document, a member of a project related to the document, or a member of a team to which the document corrector belongs.

The acquisition unit 25 further obtains attribute information of an operator of a user terminal 70. Examples of the attribute information include an official position of the operator of the user terminal 70, a department to which the operator belongs, years of service, and a role in a project in an organization. For example, the acquisition unit 25 obtains the attribute information by searching a database of personnel information using identification information of the operator of the user terminal 70 as a search key. Examples of the identification information of the operator include a name and identification (ID) of the operator. The acquisition unit 25 may obtain, as the attribute information, a relationship between the operator of the user terminal 70 and the document corrector. Examples of the relationship include a relationship between a supervisor and a subordinate, and members of the same project team. The acquisition unit 25 may obtain the attribute information of the operator of the user terminal 70 by requesting the user terminal 70 to input the attribute information.

The estimation unit 23 further estimates the change history of the document using the message information. The change history is information that organizes a process by which the document has been changed in time series. The estimation unit 23 estimates the change history by inputting the message information obtained by the acquisition unit 25 and instruction information to a generative model. The instruction information includes an instruction for requesting estimation of the change history of the document. For example, the instruction information includes an instruction such as “estimate a change history of the document using message information”. The instruction information may include an instruction for estimating information regarding an origin of the change and a process of the change. For example, the instruction information may include an instruction such as “refer to the message information and output the process of changing the document in chronological order”. The instruction information may further include an instruction for summarizing discussion of a proposed change, an instruction for outputting the date and time of the proposed change has been discussed, an instruction for including, in the output information, identification information of a person who has proposed the change, and the like. The method by which the estimation unit 23 estimates the change history is not limited to the method described above, and other methods may be used such as other machine learning processing, rule-based estimation, and the like.

The output unit 24 generates output information according to the attribute information of the operator of the user terminal 70. The output unit 24 outputs the generated output information.

The output unit 24 may generate output information according to the official position of the operator of the user terminal 70. For example, the output unit 24 may generate output information including information regarding changed portions not directly affecting the content, such as error correction, format correction, and the like, if the official position of the operator of the user terminal 70 is a proofreader, and otherwise, it may generate output information not including the changed portions not directly affecting the content.

The output unit 24 may generate the output information in such a way that a changed portion relevant to the expertise of the operator of the user terminal 70 is displayed in a prioritized manner. For example, the output unit 24 may generate output information in which changed portions related to legal matters are displayed at the top if the department to which the operator of the user terminal 70 belongs is a legal department, and may generate output information in which changed portions related to technical matters are displayed at the top if the department to which the operator of the user terminal 70 belongs is a technical department.

The output unit 24 may change the granularity of description of the change history included in the output information depending on the years of service of the operator of the user terminal 70. For example, the output unit 24 may include a summary of the change history in the output information for a person with a longer years of service, and may include a detailed change history in the output information for a person with a shorter years of service.

The output unit 24 may generate the output information according to the role of the operator of the user terminal 70. For example, the output unit 24 may generate output information mainly including information regarding the change history and information regarding the change purpose if the role of the operator of the user terminal 70 is an approver, and may generate output information mainly including information regarding specific revised portion if the role of the operator of the user terminal 70 is an editor. For example, if the role of the operator of the user terminal 70 is an approver, the output unit 24 generates output information in which changes affecting the content, such as information update, are displayed at the top and changes not affecting the content, such as error correction, are displayed at the bottom. If the role of the operator of the user terminal 70 is an editor, the output unit 24 generates output information including, for example, information such as a position of the revised portion in the document, the detailed change history including a person who has made the change and a date and time of the change, and the like.

The generation unit 26 generates a proposed revision for the post-change document. The generation unit 26 identifies a portion of the post-change document where revision is estimated to be omitted, and generates a proposed revision for the portion. For example, the generation unit 26 generates the proposed revision by inputting the post-change document and the instruction information to the generative model. The instruction information includes, for example, an instruction for identifying a portion considered to be in need of revision in the post-change document, and an instruction for outputting the proposed revision for the portion. In another example, the generation unit 26 generates the proposed revision by inputting, to the generative model, the message information, an instruction for identifying portions to be revised from the message information, an instruction for identifying a portion of the post-change document where no revision has been made among the portions to be revised, and an instruction for generating a proposed revision in which the identified portion is revised. The output information generated by the output unit 24 may further include the proposed revision generated by the generation unit 26.

### Operation

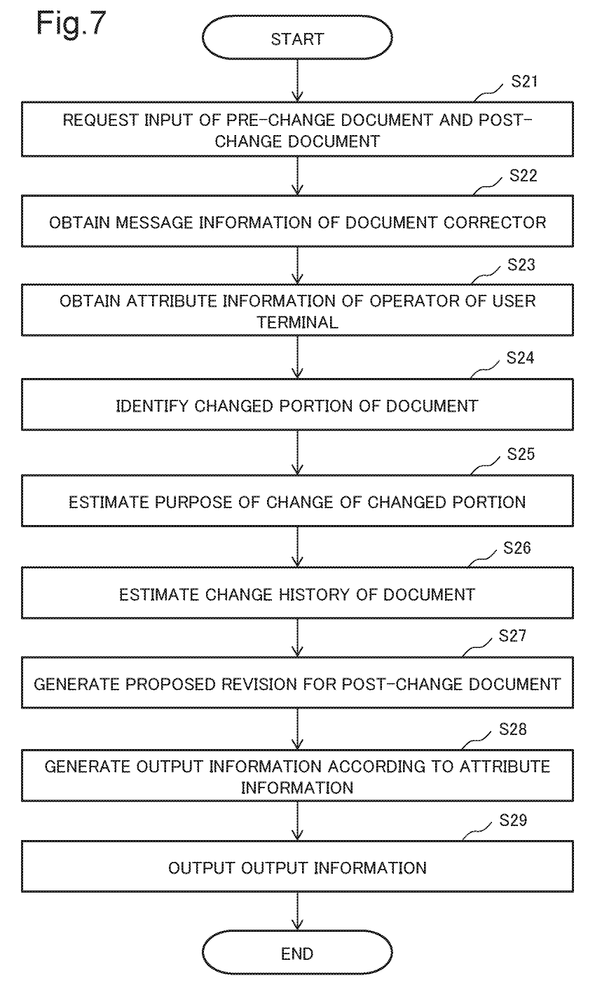

Next, an operation of the information providing device 20 will be described with reference to FIG. 7. FIG. 7 is a flowchart illustrating an exemplary operation of the information providing device according to the present disclosure.

First, the input request unit 11 requests an input of a pre-change document and post-change document (step S21). This is the same as the processing of step S11 in the first example embodiment.

Next, the acquisition unit 25 obtains the message information of the document corrector (step S22). The acquisition unit 25 obtains the attribute information of the operator of the user terminal 70 (step S23). The order of the processing of steps S21 to S23 is not limited thereto, and may be changed.

Next, the identification unit 12 identifies a changed portion of the document (step S24). Next, the estimation unit 23 estimates a purpose of the change in the changed portion (step S25). The processing of steps S24 and S25 is the same as the processing of steps S12 and S13 in the first example embodiment.

Next, the estimation unit 23 estimates a change history of the document (step S26). The generation unit 26 generates a proposed revision for the post-change document (step S27). The order of the processing of steps S25 to S27 is not limited thereto, and may be changed.

Next, the output unit 24 generates output information according to the attribute information (step S28). Next, the output unit 24 outputs the generated output information (step S29). Upon completion of the processing of step S29, the information providing device 20 terminates the series of processing described above.

The information providing device according to the present example embodiment is configured as described above. The information providing device according to the present example embodiment has the following effects in addition to the effects obtained from the information providing device according to the first example embodiment.

The information providing device according to an aspect of the present example embodiment further includes the acquisition unit that obtains the message information, which is transmitted and received by the document corrector via the message application and includes the information regarding a comment that has caused the document to be changed. The estimation unit further estimates the change history of the document using the message information. The output information further includes the information regarding the change history. With the output information including the change history, the reader of the document who checks the output information is enabled to determine the importance of the change according to the change history of the document. This makes it possible to efficiently understand the document within a limited time by reading the document while prioritizing the changes depending on their importance. That is, according to the information providing device according to the present example embodiment, it becomes possible to support efficient document understanding in a case where a change is made to the document.

The information providing device according to an aspect of the present example embodiment further includes the acquisition unit that obtains the attribute information of the reader of the post-change document. The output unit outputs the output information according to the attribute information. With the output information being changed according to the attribute information of the reader, information estimated to be highly important to the reader may be provided. That is, according to the information providing device according to the present example embodiment, it becomes possible to support efficient document understanding in a case where a change is made to the document.

In the information providing device according to an aspect of the present example embodiment, the attribute information is the department to which the reader belongs. The output unit outputs the output information in which a changed portion relevant to the expertise of the department to which the reader belongs is displayed in a prioritized manner. The information relevant to the expertise of the department to which the reader belongs is presumed to be information of high importance to the reader. With the output information displaying the changed portion relevant to the expertise of the department to which the reader belongs in a prioritized manner, the information providing device according to the present example embodiment may support efficient document understanding in a case where a change is made to the document.

In the information providing device according to an aspect of the present example embodiment, the attribute information is the role of the reader. The output unit changes the output information to be displayed in a prioritized manner depending on the role. As a result, information estimated to be required is displayed in a prioritized manner depending on the role, whereby the information providing device according to the present example embodiment may support efficient document understanding in a case where a change is made to the document.

The information providing device according to the present example embodiment further includes the acquisition unit that obtains the message information of the document corrector and the generation unit that generates a proposed revision for the post-change document using the message information. As a result, a position that has failed to be revised may be identified in the post-change document to generate a proposed revision therefor.

### Hardware Configuration

Each function of the components described above in the example embodiments of the present disclosure may be implemented not only by hardware but also by a computer device or firmware based on program control.

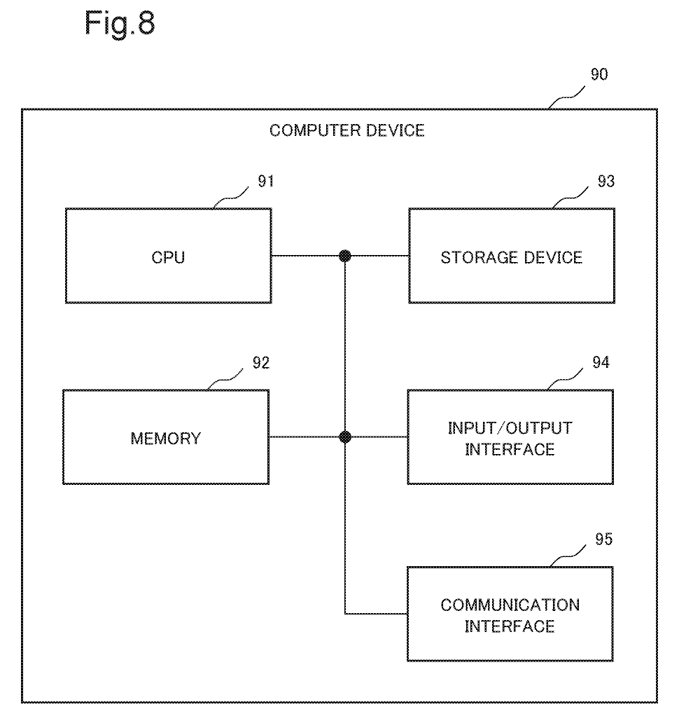

FIG. 8 is a diagram illustrating an exemplary hardware configuration in which the information providing device according to the present disclosure is implemented by a computer device 90 including a processor. The information providing device according to each of the example embodiments is implemented by the computer device 90. As illustrated in FIG. 8, the computer device 90 includes a processor 91, a memory 92, a storage device 93 for storing programs, such as a hard disk, an input/output interface 94 for connection to an input device and an output device, and a communication interface 95 for network connection.

The processor 91 loads a program (command) stored in the storage device 93 or the like into the memory 92. For example, the program is a software program for executing control and processing according to the present disclosure. The processor 91 executes the program loaded into the memory 92. The processor 91 executes the control and processing according to the present disclosure by executing the program.

Examples of the storage device 93 include an optical disk, a flexible disk, a magneto-optical disk, an external hard disk, and a semiconductor memory. Some of the storage media included in the storage device 93 are non-volatile storage devices in which programs are recorded. The programs may be downloaded from an external computer (not illustrated) connected to a communication network.

For example, the input device connected to the input/output interface 94 is implemented by a mouse, a keyboard, or the like, and is used for input operation. Likewise, for example, the output device connected to the input/output interface 94 is implemented by a display or the like, and is used to display and check an output result.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be appropriately combined with other example embodiments.

Some or all of the example embodiments described above may also be described as the following Supplementary Notes.

### Supplementary Note 1

An information providing device including:
an input request means for requesting an input of a pre-change document and a post-change document;
an identification means for identifying a changed portion of a document by comparing the pre-change document with the post-change document;
an estimation means for estimating a change purpose of the changed portion identified by the identification means by inputting the changed portion and instruction information for requesting estimation of the change purpose of the changed portion to a generative model that outputs the change purpose of the changed portion using, as an input, the changed portion and the instruction information for requesting the estimation of the change purpose of the changed portion; and
an output means for outputting output information including the changed portion and the change purpose.

### Supplementary Note 2

The information providing device according to Supplementary Note 1, in which
the input request means further requests an input of the change purpose not desired to be output, and
in a case where a plurality of the changed portions is identified and a plurality of the change purposes associated with the plurality of changed portions is estimated, the output means generates the output information not including the changed portion associated with, among the plurality of change purposes, the change purpose for which the input indicating that an output is not desired has been received.

### Supplementary Note 3

The information providing device according to Supplementary Note 1, in which the output means does not include, in the output information, the changed portion associated with the change purpose of error correction.

### Supplementary Note 4

The information providing device according to Supplementary Note 1, further including:
an acquisition means for obtaining message information including information regarding a comment that has caused the document to be changed, the message information being transmitted and received by a document corrector via a message application, in which
the estimation means further estimates a change history of the document using the message information, and
the output information further includes information regarding the change history.

### Supplementary Note 5

The information providing device according to Supplementary Note 1, further including:
an acquisition means for obtaining attribute information of a reader of the post-change document,
in which the output means outputs the output information according to the attribute information.

### Supplementary Note 6

The information providing device according to Supplementary Note 5, in which
the attribute information includes a department to which the reader belongs, and
the output means outputs the output information in which the changed portion relevant to expertise of the department to which the reader belongs is displayed in a prioritized manner.

### Supplementary Note 7

The information providing device according to Supplementary Note 5, in which
the attribute information includes a role of the reader, and
the output means changes the output information to be displayed in a prioritized manner depending on the role.

### Supplementary Note 8

The information providing device according to Supplementary Note 1, further including:
an acquisition means for obtaining message information of a document corrector; and
a generation means for generating a proposed revision for the post-change document using the message information.

### Supplementary Note 9

An information providing method for causing a computer to perform a process including:
requesting an input of a pre-change document and a post-change document;
identifying a changed portion of a document by comparing the pre-change document with the post-change document;
estimating a change purpose of the changed portion identified by the identification means by inputting the changed portion and instruction information for requesting estimation of the change purpose of the changed portion to a generative model that outputs the change purpose of the changed portion using, as an input, the changed portion and the instruction information for requesting the estimation of the change purpose of the changed portion; and
outputting output information including the changed portion and the change purpose.

### Supplementary Note 10

A computer program for causing a computer to perform a process including:
requesting an input of a pre-change document and a post-change document;
identifying a changed portion of a document by comparing the pre-change document with the post-change document;
estimating a change purpose of the changed portion identified by the identification means by inputting the changed portion and instruction information for requesting estimation of the change purpose of the changed portion to a generative model that outputs the change purpose of the changed portion using, as an input, the changed portion and the instruction information for requesting the estimation of the change purpose of the changed portion; and
outputting output information including the changed portion and the change purpose.

In Supplementary Notes described above, some or all of the configurations described in Supplementary Notes 2 to 8 dependent on Supplementary Note 1 may also be dependent on Supplementary Notes 9 and 10 with dependency relationships similar to those in Supplementary Notes 2 to 8. Furthermore, some or all of the configurations described as Supplementary Notes may also be similarly dependent on not only Supplementary Notes 1, 9, and 10 but also various types of hardware or systems without departing from the example embodiments described above.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information providing device comprising:
one or more memories storing instructions; and
one or more processors configured to execute the instructions to:
request an input of a pre-change document and a post-change document;
identify a changed portion of a document by comparing the pre-change document with the post-change document;
estimate a change purpose of the identified changed portion by inputting the identified changed portion and instruction information for requesting estimation of the change purpose to a generative model configured to output the change purpose based on the changed portion and the instruction information as inputs; and
output output information including the changed portion and the change purpose.

2. The information providing device according to claim 1, wherein
the one or more processors are further configured to execute the instructions to:
request an input of the change purpose not desired to be output; and
in a case where a plurality of the changed portions is identified and a plurality of the change purposes associated with the plurality of changed portions is estimated, generate the output information not including the changed portion associated with, among the plurality of change purposes, the change purpose for which the input indicating that an output is not desired has been received.

3. The information providing device according to claim 1, wherein the one or more processors are further configured to execute the instructions to not include, in the output information, the changed portion associated with the change purpose of error correction.

4. The information providing device according to claim 1, wherein
the one or more processors are further configured to execute the instructions to:
obtain message information including information regarding a comment that has caused the document to be changed, the message information being transmitted and received by a document corrector via a message application;
estimate a change history of the document using the message information; and
include, in the output information, information regarding the change history.

5. The information providing device according to claim 1, wherein
the one or more processors are further configured to execute the instructions to:
obtain attribute information of a reader of the post-change document; and
output the output information according to the attribute information.

6. The information providing device according to claim 5, wherein
the attribute information includes a department to which the reader belongs, and
the one or more processors are configured to execute the instructions to output the output information in which the changed portion relevant to expertise of the department to which the reader belongs is displayed in a prioritized manner.

7. The information providing device according to claim 5, wherein
the attribute information includes a role of the reader, and
the one or more processors are configured to execute the instructions to output the output information in which information is displayed in a prioritized manner depending on the role.

8. The information providing device according to claim 1, wherein
the one or more processors are further configured to execute the instructions to:
obtain message information of a document corrector; and
generate a proposed revision for the post-change document using the message information.

9. An information providing method comprising:
by a computer,
requesting an input of a pre-change document and a post-change document;
identifying a changed portion of a document by comparing the pre-change document with the post-change document;
estimating a change purpose of the identified changed portion by inputting the identified changed portion and instruction information for requesting estimation of the change purpose to a generative model configured to output the change purpose based on the changed portion and the instruction information as inputs; and
outputting output information including the changed portion and the change purpose.

10. A non-transitory recording medium recording a computer program for causing a computer to execute:
requesting an input of a pre-change document and a post-change document;
identifying a changed portion of a document by comparing the pre-change document with the post-change document;
estimating a change purpose of the identified changed portion by inputting the identified changed portion and instruction information for requesting estimation of the change purpose to a generative model configured to output the change purpose based on the changed portion and the instruction information as inputs; and
outputting output information including the changed portion and the change purpose.
